(19) United States
(12) Patent Application Publication
(10) Pub. No.: US 2016/0207367 A1
(43) Pub. Date: Jul. 21, 2016

(54) Apparatus and Method for Conveying Information

(71) Applicant: Bendix Commercial Vehicle Systems LLC, Elyria, OH (US)

(72) Inventors: Daniel P. Zula, North Ridgeville, OH (US); Timothy J. Frashure, Columbia Station, OH (US); Jon D. Intagliata, Avon, OH (US); Brian S. Bernard, Avon Lake, OH (US); Joseph M. Macnamara, Ashland, OH (US)

(21) Appl. No.: 14/601,964

(22) Filed: Jan. 21, 2015

(51) Int. Cl. B60D 1/62; B60C 23/02; B60T 8/17

(52) U.S. Cl. CPC B60D 1/62; B60T 8/1708; B60C 23/02

(57) ABSTRACT

A system for conveying information includes a visual signaling device and a processor. The visual signaling device is capable of simultaneously displaying a plurality of messages. The processor electrically communicates with the visual signaling device. The processor receives a plurality of messages from respective systems via a communication system, identities a respective priority and at least one respective attribute of each of the messages, and transmits signals based on the priorities of the messages to cause the visual signaling device to simultaneously convey the respective priority and at least one attribute of at least one of the messages. The respective priorities and the at least one attributes of each of the messages is previously assigned, and a diagnostic message having a lowest of the priorities is previously assigned.

### BACKGROUND

The present invention relates to conveying messages from various trailer systems to an operator in a traction portion of a vehicle. It finds particular application in conjunction with conveying the messages based on their respective priorities and will be described with particular reference thereto. It will be appreciated, however, that the invention is also amenable to other applications.

Heavy vehicles such as trucks may be articulated and include a towing portion (e.g., a tractor) and a towed portion (e.g., a trailer). It is becoming more common for the towed portion of an articulated vehicle to include different trailer systems that require electricity. For example, a vehicle trailer may include a tire inflation system, a tire pressure monitoring system, a trailer refrigeration system, and or an antilock braking system (ABS), etc. Such systems may include built-in diagnostics to monitor the respective systems' functionality. However, not all of the trailer systems have a generally adopted scheme for conveying diagnostic information from the respective trailer system to an operator of the vehicle (e.g., a driver) in a cab of the tractor.

Some trailer systems use a lamp mounted on a bulkhead of the trailer to convey system status to the operator. The lamp is mourned on the driver-side of the trailer and is visible from the driver's rear-view minor. Currently, however, each system needs a dedicated lamp indicator installed on the trailer bulkhead. In addition, additional wiring is required from each system to the trailer bulkhead. Trailer original equipment manufacturers ((DEWS) are typically tasked with installing the additional wiring, Regardless of who installs it such additional wiring adds cost and complexity to a vehicle trailer.

The present invention provides a new and improved apparatus and method which addresses the above-referenced problems.

### SUMMARY

In one embodiment, a system for conveying information includes a visual signaling device and a processor. The visual signaling device is capable of simultaneously displaying a plurality of messages. The processor electrically communicates with the visual signaling device. The processor receives a plurality of messages from respective systems via a communication system, identifies a respective priority and at least one respective attribute of each of the messages, and transmits signals based on the priorities of the messages to cause the visual signaling device to simultaneously convey the respective priority and at least one attribute of at least one of the messages. The respective priorities and the at least one attributes of each of the messages is previously assigned, and a diagnostic message having a lowest of the priorities is previously assigned.

### BRIEF DESCRIPTION OF THE DRAWINGS

In the accompanying drawings which are incorporated in and constitute a part of the specification, embodiments of the invention are illustrated, which, together with a general description of the invention given above, and the detailed description, given below, serve to exemplify the embodiments of this invention.

FIG. 1 illustrates a perspective view of a vehicle including a system for conveying messages from a towed portion of the vehicle to a towing portion of the vehicle in accordance with one embodiment of an apparatus illustrating principles of the present invention;

FIG. 2 illustrates a schematic representation of the vehicle of FIG. 1 including the system for conveying messages in accordance with one embodiment of an apparatus illustrating principles of the present invention;

FIG. 3 illustrates a schematic representation of a signaling device in accordance with one embodiment of an apparatus illustrating principles of the present invention;

FIG. 4 is an exemplary methodology of conveying messages from various systems on the towed portion of the vehicle to the towing portion of the vehicle in accordance with one embodiment illustrating principles of the present invention; and

FIG. 5 illustrates a table indicating respective message numbers, priorities, and display times.

### DETAILED DESCRIPTION OF ILLUSTRATED EMBODIMENT

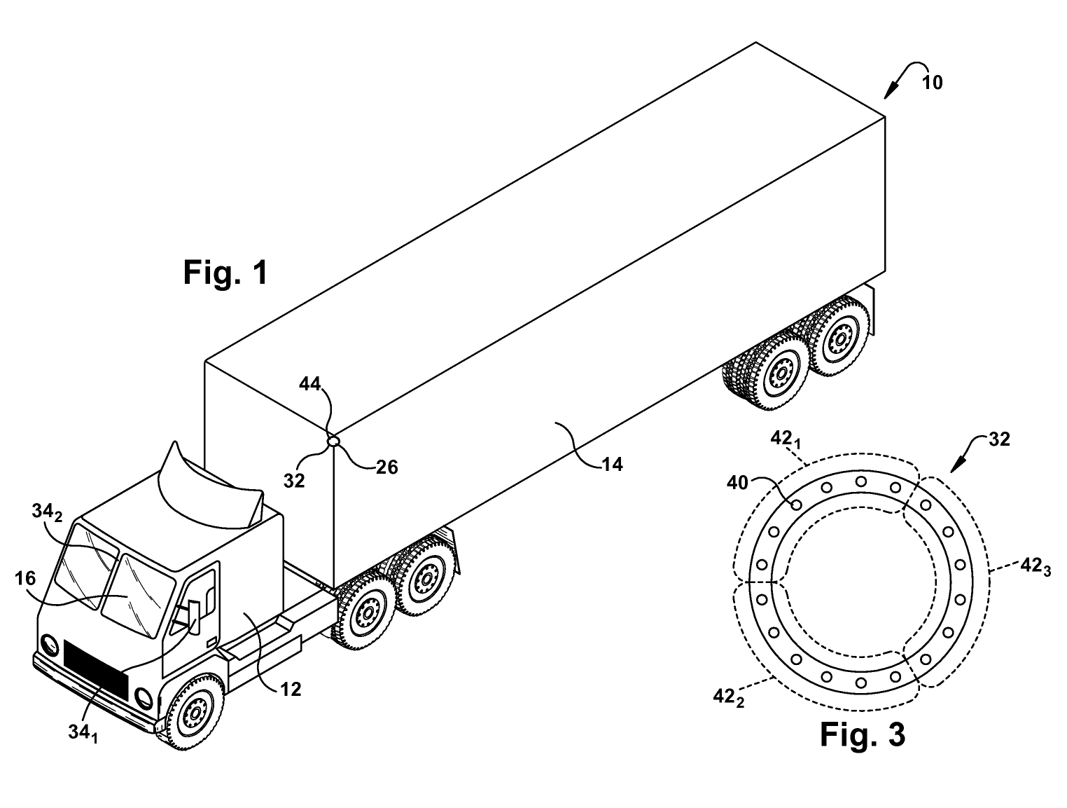

With reference to FIG. 1, a perspective view of a vehicle 10 is illustrated in accordance with one embodiment of the present invention. The vehicle 10 includes a towing portion 12 (e.g., a tractor) and towed portion 14 (e.g., a trailer). The towing portion 12 includes a cab 16 for accommodating an operator (e.g., a driver) of the vehicle 10.

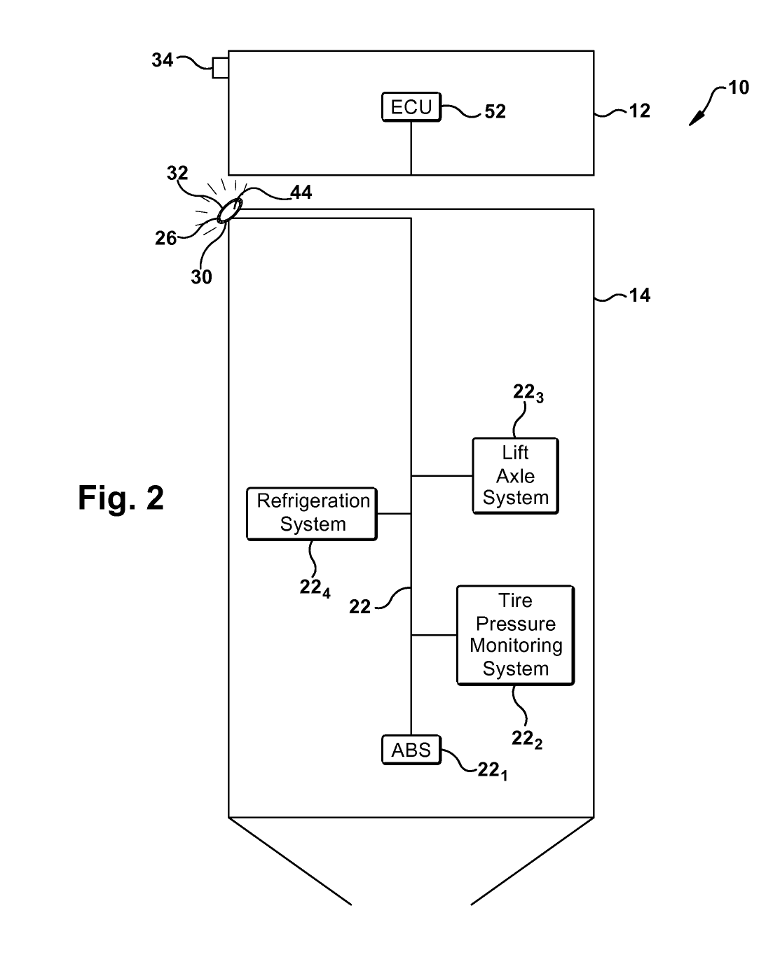

FIG. 2, illustrates a simplified top view of a component diagram of the towing portion 12 and the towed portion 14 of the vehicle 14) in accordance with one embodiment of the present invention. The towed portion 14 includes a plurality of towed portion systems 20, in the illustrated embodiment, the towed portion 14 includes an antilock braking system (ABS) 20₁, a tire pressure monitoring system (TPMS) 20₂, a lift axle system 20₃, and a trailer refrigeration unit 20₄. Although four (4) towed portion systems 20₁₋₄ (collectively 20) are shown, it is to be understood that any number of different systems and/or other systems are contemplated. Each of the towed portion systems 20₁₋₄ electrically communicates with a trailer communication bus 22.

The trailer communication bus 22 is contemplated to include a plurality of lines for electrically communicating messages between the various towed portion systems 20 and other systems on the vehicle 10. For example, the trailer communication bus 22 typically communicates with a tractor communication bus 24 so that messages can be electrically communicated between the towed portion 14 and towing portion 12 of the vehicle 10. One of the lines in each of the trailer communication bus 22 and the tractor communication bus 24 is a respective power line communication (PLC) carrier. Generally, a power line communication carrier supplies electrical power to the respective systems (e.g., the towed portion systems 20). In addition, a power line communication carrier is capable of transmitting messages (e.g., status messages) to/from a system (e.g., a towed portion system 20) to which the PLC is supplying power. Therefore, the PLC carrier is also referred to more generally as a communication system. In that regard, other forms of communication such as a controller area network (CAN) bus and WiFi are also contemplated.

As discussed above, systems 20 on the towed portion 14 of the vehicle 10 convey information from the towed portion 14 to the towing portion 13 of the vehicle 10. In one embodiment, the information is conveyed to the operator in the cab 16.

With reference to FIGS. 1 and 2, a communication system 25 on the towed portion 14 of the vehicle 10 is used to convey information. The communication system 26 includes a processor 30 and a signaling device 32. In one embodiment, the processor 30 and the signaling device 32 are integrated to form the communication system 26. Although the processor 30 and the signaling device 32 are illustrated as integrated, it is to be understood that other embodiments in which the processor 30 is separate from the signaling device 32 (e.g., the processor 30 and the signaling device 32 are not included in a common housing) are also contemplated.

The processor 30 of the communication system 26 electrically communicates with, and is powered by, the trailer communication bus 22. For example, the processor 30 is powered by the power line communication carrier (e.g., the communication system) of the trailer communication bus 22. Messages (e.g., status messages) transmitted by the various towed portion systems 20₁₋₃ are electrically communicated along the power line communication carrier (e.g., the communication system) portion of the trailer communication bus 22. The messages are received by the processor 30 of the signaling device 32 from the power line communication carrier (e.g., the communication system).

The signaling, device 32 electrically communicates with the processor 30. In one embodiment, the signaling device 32 of the communication system 26 provides a visual signal and, therefore, is referred to as a visual signaling device. It is contemplated that the signaling, device 32 is positioned toward a forward portion of the towed portion 14 of the vehicle 10. In that position, it is anticipated that the vehicle operator is capable of seeing the signaling device 32 via a mirror 34 (e.g., a side mirror 34₁ of the vehicle 10 or a rear view mirror 34 in the cab 16) on the towing portion 12 of the vehicle 10. In the illustrated embodiment, the signaling device 32 is positioned on a driver side of the towed portion 14 of the vehicle 10.

FIG. 3 illustrates one embodiment of the visual signaling device 32. With reference to FIGS. 1-3, the visual signaling device 32 is configured as a ring (e.g., a circle) including a plurality of lights 40. In one embodiment, each of the lights 40 is a light emitting device (e.g., a light emitting diode (LED), e-paper, vacuum fluorescent incandescent light, liquid crystal display (LCD), organic LED, plasma, etc). It is contemplated that each of the lights 40 is capable of displaying a plurality of different colors. Each of the individual lights 40 of the signaling device 32 is illuminated in response to receiving signals transmitted from the processor 30. The processor 30 creates and transmits the signals to the signaling device 32 to control various attributes of the respective individual lights 40. The various attributes include, for example, the color, a blink rate (e.g., blink pattern), a display time, and a physical pattern of the respective individual lights 40.

It is contemplated that the processor 30 periodically transmits the signals to control illumination of the lights 40 at, for example, regular time intervals. In one embodiment, the processor 30 transmits the signals to control illumination of the lights 40 every 0.1 second. However, other time intervals for transmitting the signals are also contemplated. The blink rate and display time of the respective lights 40 may be controlled by the sequentially transmitted signals from the processor 30. For example, if it is desired that one of the lights 40 blinks “on” for 0.1 second and the “off” for 0.1 second for a total of ten (10) seconds, the signals transmitted from the processor 30 to the respective light 40 alternately causes the light 40 to be illuminated (e.g., “on”) and then not illuminated (e.g., “off”) for a total of ten (10) seconds. In other words, if the processor 30 transmits signals to the lights 40 every 0.1 second, the processor 30 transmits a signal to illuminate the light 40 in one transmission, which causes the light 40 to illuminate for 0.1 second, and next transmits a signal to not illuminate the light 40 in a next transmission, which causes the light 40 to not be illuminated for 0.1 second. The effect of alternately illuminating and not illuminating a light causes the light 40 to blink. If an individual light 40 is desired to be continuously illuminated for five (5) seconds, each of the signals transmitted from the processor 30 for period of five (5) seconds causes the light 40 to illuminate.

The individual lights 40 may be illuminated together by the processor 30 to form respective segments 42 (e.g., display areas) within the signaling device 32. Each of the segments 42 may be used to convey a respective message. Therefore, dividing the signaling device 32 into the segments 42 makes the signaling device 32 capable of simultaneously conveying a plurality of messages from the various towed portion systems 20. The illustrated embodiment includes three (3) segments 42₁, 42₃, 42₃ (collectively 42). However, other embodiments including any number of segments are also contemplated.

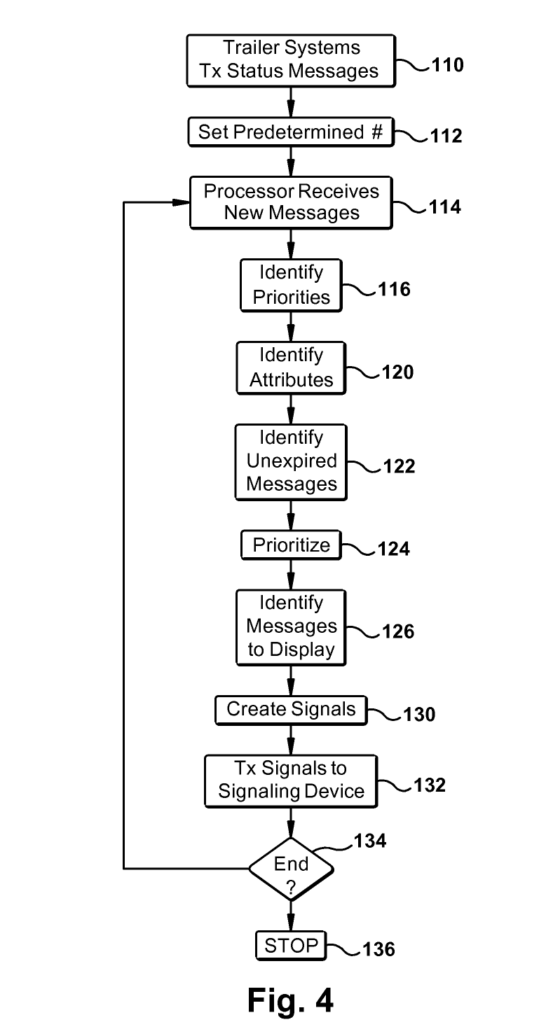

With reference to FIG. 4, an exemplary methodology of the system shown in FIGS. 1-3 conveying information is illustrated. As illustrated, the blocks represent functions, actions and/or events performed therein. It will be appreciated that electronic, and software systems involve dynamic and flexible processes such that the illustrated blocks and described sequences can be performed in different sequences. it will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-4, in a step 110, the towed portion systems 20 are assumed to be continuously transmitting respective messages (e.g., status messages). Then, a predetermined number of messages (e.g., a subset of messages) to simultaneously convey via the signaling, device 32 is identified in a step 112. The number of messages to simultaneously display in one embodiment is contemplated to be three (3). However, any other number of messages to display simultaneously is also contemplated.

At least one new message from the towed portion system 20 is received by the processor 30 in a step 114. As described above with reference to the step 110, it is contemplated that the towed portion systems 20 are continuously transmitting messages. Therefore, it is assumed that the processor 30 previously received messages prior to the at least one new (e.g., current) message being received by the processor 30 in the step 114.

Respective priorities of the at least one new message received in the step 114 are identified in a step 116. Similarly, at least one respective attribute of the at least one new message received in the step 114 is/are identified in a step 120.

In one embodiment, the priorities and attributes for the messages are assigned (e.g., read) from a lookup table 44. it is contemplated that the lookup table 44 is previously populated with pre-defined messages that may be received from any of the towed portion systems 20. Respective priorities and attributes are previously defined (e.g., assigned) by a user and associated with each of the pre-defined messages in the lookup table 44. The priorities are defined (e.g., previously defined by a user), for example, between a highest priority of one (1) and a lowest priority of twenty-live (25). As discussed above, the attributes may include color, blink rate (e.g., blink pattern), display time, and physical pattern. A diagnostic message having a lowest of the priorities is also included in the lookup table 44. As discussed in more detail below, if no other received messages are included in the lookup table, 44, the diagnostic message will have the highest of the priorities in the lookup table 44.

For example, a status message from the towed portion 14 ABS 20₁ indicating normal operation would be associated with a relatively lower priority (e.g., a priority of twenty (20)), a blink rate of zero (0) (e.g., no blink) since the priority is relatively low (e.g., greater than, for example, five (5)), and a relatively short display time of for example, three (3) seconds since the priority is relatively low (e.g., greater than, for example, five (5)). The color attribute associated with any message from the towed portion 14 ABS 20₁ may, for example, be red.

In another example, another status message from the trailer refrigeration unit 20₄ indicating a temperature of a refrigerated compartment associated with the refrigeration unit 20₄ is slightly above a predetermined threshold (e.g., the temperature inside the refrigerated compartment is 40° F., which is 2° F. above a threshold of 38° F.) may, for example, be assigned a blink, rate of zero (0), a moderate priority of ten (10), and a moderate display time of, for example, ten (10) seconds. The color attribute associated with any message from the trailer refrigeration unit 20₄ may, for example, he green. However, another status message from the trailer refrigeration unit 20₄ indicating a temperature of a refrigerated compartment associated with the refrigeration unit 20₄ is significantly above the predetermined threshold (e.g., the temperature inside the refrigerated compartment is 50° F., which is 12° F. above a threshold of 38° F.) may, for example, be assigned a blink rate of 0.1 seconds, a relatively high priority of (4), and a relatively longer display time of, for example, eighteen (18) seconds. As noted above, the color attribute associated with any message from the trailer refrigeration unit 20₄ may, for example, be green.

In another example, a status message indicating a compressor of the trailer refrigeration unit 20₄ is malfunctioning (even if the temperature of a refrigerated compartment associated with the refrigeration unit 20₄ has not yet risen above the predetermined threshold) may, for example, be assigned a blink rate of 0.1 seconds, a relatively high priority of three (3), and a relatively longer display time of for example, twenty (20) seconds. Again, the color attribute associated with any message from the trailer refrigeration unit 20₄ may, for example, be green.

If the processor 30 receives a message not previously included in the lookup table 44, a relatively slower blink rate of 0.4 seconds, a moderate priority of twelve (12), and a relatively longer display time of, for example, twenty-two (22) seconds may be assigned. As noted above, the color attribute will be assigned based on the towed portion system 20 from which the message is received.

In a step 122, any previously received messages that have not yet expired are identified. Unexpired messages are those messages for which the display time has not yet “timed-out” (e.g., the display time has not yet counted down to zero (0)). Then, in a step 124, any of the at least one new messages received in the step 114 and the previously received unexpired messages identified in the step 122 are prioritized. in this regard, the at least one new message received in the step 114 is sorted with the previously received unexpired messages identified in the step 122 based on the respective priorities of the messages.

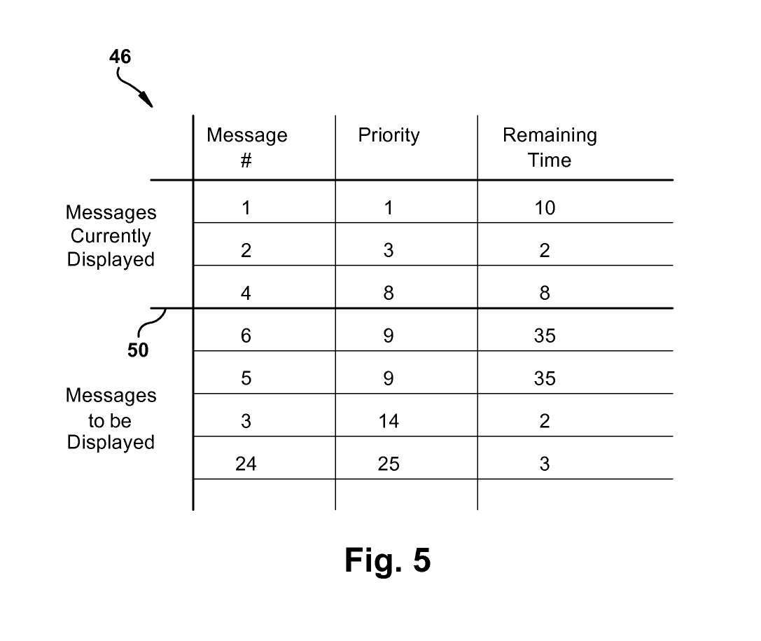

With reference to FIG. 5, an exemplary table 46 showing information of various messages received by the processor 30 (see FIG. 2) is shown after the messages have been sorted by priority in the step 122. The table 46 of messages includes three (3) columns: “Message #”, “Priority”, and “Remaining Time”. The “Message #” column identifies a sequential number assigned to messages received by the processor 30. Messages assigned numbers 7-23 are not included in the table 46 because, for example, those messages have timed-out. The “Priority” column, which identifies the message priority assigned from the lookup table 44, is sorted in ascending order. The “Remaining Time” column indicates the number of seconds left before each of the respective messages times-out.

With reference again to FIGS. 1-4 and further reference to FIG. 5, the predetermined number of messages to display (see the step 112 above) on the signaling device 32 are identified in a step 126. For example, if the predetermined number of messages to display is set as three (3) in the step 112, the messages in the table 46 having. the top three (3) priorities are identified in the step 126. In the current example, the messages in the table 46 having the top three (3) priorities are message numbers 1, 2, and 4 (see the “Message #” column), which have priorities of 1, 3, and 8 (see the “Priority” column), respectively. For illustration purposes only, a line 50 is included in the table 46 shown in FIG. 5. The messages above the line 50 (i.e., message numbers 1, 2, and 4 (see the “Message #” column)) are messages to he displayed using the signaling device 32, and the messages below the line 50 (i.e., message numbers 3, 5, 6, and 24 (see the “Message #” column)) will not be displayed.

It is contemplated that if for example, four (4) messages have a priority of one (1), but only three (3) messages are to be displayed (see the step 112 above), the step 126 determines that the three (3) messages having the shortest remaining time will be displayed.

In a step 130, the processor 30 generates signals for illuminating the signaling, device 32, The signals generated by the processor 30 control each of the lights 40 in the signaling device 32 to either illuminate or not illuminate a respective color for the duration of the time interval (e.g., 0.1 seconds). In addition the signals generated by the processor 30 control each of the lights 40 to create the segments 42 in the signaling device 32.

In one embodiment, the message having the highest priority the message number 1 (see the “Message #” column)) is displayed using a largest of the segments 42₁ (display areas). In the illustrated embodiment, the message number 1 is displayed using the segment 42₁, which is about one-half of a top of the signaling device 32. The remaining two (2) of the messages to be displayed (e.g., the message numbers 2 and 4 (see the “Message #” column)) are displayed using segments 42₂, 42₃ (display areas) that are smaller than the segment 42₁ (display area). For example, the remaining two (2) of the messages are displayed using substantially equal portions of the about one-half of a bottom of the signaling device 32. For example, the message number 2 is displayed using the segment 42₂ and the message number 4 is displayed using the segment 42₃.

In another embodiment, the processor 30 generates the signals so that each of the messages to be displayed (i.e., message numbers 1, 2, and 4 (see the “Message #” column)) is displayed in a segment sized proportionally to the priority of the message. For example, the message having the highest priority may be displayed using a segment covering about 45% of the signaling device 32, the message having the next highest priority may be displayed using a segment covering about 35% of the signaling device 32, and the message having the lowest priority may be displayed using a segment covering about 20% of the signaling device 32.

In a step 132, the signals generated in the step 130 are transmitted to the signaling device 32. Then, in a step 134, a determination is made whether to end the process. If the process is to continue, control returns to the step 114 before generating and transmitting subsequent signals in the steps 130 and 132. Otherwise, control passes to a step 136 to end the process.

Although the signaling device 32 has been described as a ring e.g., a circle) including a plurality of the lights 40, it is to be understood that the signaling device 32 may be any shape. in addition, the lights 40 on the signaling device 32 may be arranged in a grid-like pattern so that various ones of the lights 40 may be illuminated to display different pattern attributes (e.g., icons).

In the embodiments disclosed above, the visual signaling device 32 acts as a means for simultaneously displaying a plurality of messages. In addition, the processor 30 acts as a means for receiving a plurality of messages from respective systems via a power line communication carrier (e.g., the communication system), identifying a respective previously assigned priority and at least one respective previously assigned attribute of each of the messages, and transmitting signals based on the priorities of the messages to cause the means for simultaneously displaying to simultaneously convey the respective priority and at least one attribute of at least one of the messages.

In another embodiment, it is contemplated that the processor 30 also acts as a gateway between various the towed portion systems 20 and an electronic control unit (ECU) 52 in the towing portion 12 of the vehicle 10. In that regard, the processor 30 acts as a translator between the various towed portion systems 20 and the towing portion ECU 52. For example, the processor 30 reformats messages (e.g., translates the messages) between formats compatible with the towed portion systems 20 and the towing portion ECU 52. in one embodiment, one or more of the towed portion systems 20 may transmit messages according to a standard J1939 format, while other of the towed portion systems 20 and the towing portion ECU 52 transmit messages according to another format In this case, the processor 30 receives the messages from one or more of the towed portion systems 20 and the towing portion ECU 52, determines if the destination (e.g., one of the towed portion systems 20 and the towing portion ECU 52) is capable of receiving the message in its current format (e.g., standard J1939 format), reformats (e.g., translates) the messages, if necessary, into the message format used by the destination (e.g., one of the towed portion systems 20 and the towing portion ECU 52), and transmits the reformatted message back to the towed portion communication bus 22. In this way, the processor 30 acts to “repeat” messages between the various towed portion systems 20 and the towing portion ECU 52. In addition, if the processor 30 determines that the received message format is compatible with the destination (e.g., one of the towed portion systems 20 and the towing portion ECU 52), the processor 30 also has the ability to simply repeat the message without any interpretation for the signaling device 32.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A system for conveying information, the system comprising:
a visual signaling device, capable of simultaneously displaying a plurality of messages; and
a processor, electrically communicating with the visual signaling device, receiving a plurality of messages from respective systems via a communication system, identifying a respective priority and at least one respective attribute of each of the messages, and transmitting signals based on the priorities of the messages to cause the visual signaling device to simultaneously convey the respective priority and at least one attribute of at least one of the messages, the respective priorities and the at least one attributes of each of the messages being previously assigned, and a diagnostic message having a lowest of the priorities being previously assigned.

2. The system for conveying information as set forth in claim 1, wherein:
the visual signaling device includes a plurality of display areas.

3. The system for conveying information as set forth in claim 2, wherein:
the visual signaling device includes a plurality of segments and each of the display areas includes at least one of the segments.

4. The system for conveying information as set forth in claim 2, wherein:
each of the simultaneously displayed messages is displayed in a respective one of the display areas.

5. The system for conveying information as set forth in claim 4, wherein:
the message assigned a most important of the priorities is displayed in a largest of the display areas; and
any of the other messages assigned a priority that is not the most important of the priorities is displayed in respective display areas smaller than the largest display area.

6. The system for conveying information as set forth in claim 5, wherein the at least one attribute includes:
a color to display on the visual signaling device, a blink rate to display on the visual signaling device, a time to display on the visual signaling device, and an icon to display.

7. The system for conveying information as set forth in claim 6, wherein the at least one attribute includes:
the color is based the respective system.

8. The system for conveying information as set forth in claim 6, wherein:
the blink rate is based On the priority of the respective message; and
the time to display is based on the priority of the respective message.

9. The system for conveying information as set forth in claim 4, wherein:
the respective sizes of the display areas are based on the relative priorities of the messages.

10. The system for conveying information as set forth in claim 1, wherein:
the visual signaling device includes a plurality of display areas; and
the processor transmits the signals to display a predetermined number of the messages.

11. The system for conveying information as set forth in claim 10, wherein:
the processor receives an additional message;
the processor identifies a respective priority and at least one respective attribute of the additional message;
the processor identifies any of the plurality of messages remaining active; and
the processor transmits subsequent signals based on the priorities of the additional message and the remaining active messages to cause the visual signaling device to simultaneously Convey the respective priority and at least one attribute of at least one of the additional message and the remaining active messages.

12. The system for conveying information as set forth in claim 1, wherein:
the visual signaling device is on a towed portion of a vehicle:
the processor is on the towed portion of the vehicle;
the systems are on the towed portion of the vehicle; and
the visual signaling device is visible to a driver on a towing portion of the vehicle.

13. The system for conveying information as set forth in claim 1, further including:
an electronic control unit on a towing portion of a vehicle;
wherein:
the visual signaling device is on a towed portion of the vehicle;
the processor is on the towed portion of the vehicle;
the systems are on the towed portion of the vehicle;
the processor determines if any of the messages received from the any of the electronic control unit and the systems on the towed portion of the vehicle must be reformatted to be received by a destination including any of the electronic control unit and the systems on the towed portion of the vehicle; and
the processor transmits the received messages destined for any of the electronic control unit and the systems on the towed portion of the vehicle via the communication system.

14. The system for conveying information as set forth in claim 1, wherein:
the communication system includes, a power line communication carrier.

15. A control unit for an associated visual signaling device, the control unit comprising:
a processor capable of receiving a current system message, via a communication system, front a respective electrical, system on a towed portion of a vehicle, capable of associating a previously assigned priority and it least one previously assigned attribute to the current system message, capable of prioritizing the current system message with any unexpired previous system messages, capable of identifying up to a predetermined number of the current system message and the unexpired previous system messages to be conveyed via the associated visual signaling device, and capable of transmitting signals to the associated signaling device based on the identified prioritized current system message and unexpired previous system messages to be conveyed.

16. The control unit for an associated visual signaling device as set forth in claim 15, wherein:
the processor transmits the signals so that the identified system message having a most important of the priorities is conveyed using more of a display area of the signaling, device than respective display areas of any of the other identified system messages to be conveyed.

17. The control unit for an associated visual signaling device as set forth in claim 16, wherein:
the predetermined number of the identified system messages is three;
the identified system message having the most important of the priorities is conveyed using about one-half of display area of the signaling device; and
the other identified system messages are conveyed using about equal portions of the remaining display area of the signaling device.

18. The control unit for an associated visual signaling device as set forth in claim 15, wherein:
the processor transmits the signals so that the identified system messages are conveyed using respective display areas of the signaling device that are sized based on the respective priorities of the identified system messages to be conveyed.

19. The control unit for an associated visual signaling device as set forth in claim 15, wherein:
respective priorities and respective at least one attributes of the unexpired previous system messages are previously assigned;
the previously assigned priority and the previously assigned at least one attribute of the current system message along the previously assigned respective priorities and previously assigned at least one attribute of the unexpired previous system messages are stored in a lookup table;
the processor assigns the respective priority for each of the current system message and the previous system messages based on the priority lookup table; and
the processor assigns the respective at least one attribute for each of the current system message and the previous system messages based on an attribute lookup table.

20. The control unit for an associated visual signaling device as set forth in claim 15, wherein:
the previous system messages were received by the processor via the communication system; and
the processor previously assigned respective priorities and at least one attribute to the previous system messages.

21. The control unit for an associated visual signaling device as set forth in claim 15, wherein:
the at least one attribute includes a display time, a color, a brightness, a blink patters and a physical pattern of the respective current system message.

22. The control unit for an associated visual signaling device as set forth in claim 15, wherein:
the processor is on a towed portion of a vehicle;
the processor determines if the current message should be transmitted to an associated electronic control unit on a towing portion of the vehicle; and
if the current message should be transmitted to the associated electronic control unit, the processor reformats the message for compatibility with the associated electronic control. unit.

23. A method for conveying a plurality of messages, the method comprising:
receiving a plurality of messages from respective systems via a communication system;
identifying a previously assigned respective priority and at least one previously assigned respective attribute of each of the messages; and
transmitting signals based on the priorities of the messages to cause the visual signaling device to simultaneously convey the respective priority and at least one attribute of at least one of the messages.

24. The method for conveying a plurality of messages as set forth in claim 23, further including:
illuminating the visual signaling device to simultaneously convey the respective priority and at least one attribute of at least one of the messages.

25. The method for conveying a plurality of messages as set forth in claim 24, wherein the transmitting step includes:
transmitting the signals to simultaneously convey the respective priority and at least one attribute of a predetermined number of the messages having the highest priorities.

26. The method for conveying a plurality of messages as set forth in claim 25, wherein the illuminating step includes:
illuminating a relatively larger segment of the visual signaling device for the message having the highest priority.

27. The method for conveying a plurality of messages as set forth in claim 24, wherein the illuminating step includes:
illuminating different segments of the visual signaling device with different colors to convey the system from which the message was received; and
illuminating the different segments of the visual signaling device according to respective blink rates to convey a status of the system from which the message was received.

28. The method for conveying a plurality of messages as set forth in claim 2 wherein the illuminating step includes:
illuminating the different segments alike visual signaling device with the respective colors and blink rates for a respective time based on the message.

29. The method for conveying a plurality of messages as set forth in claim 24, further including:
determining if any of the messages is destined for any of another one of the systems on a towed portion of a vehicle and an electronic control unit on a towing portion of the vehicle;
determining if any of the messages must be reformatted for the destination; and
if any of the messages must be reformatted:
reformatting the messages for the destination; and
transmitting the messages to the destination.

30. A display system for a towed portion of a vehicle, the display system comprising::
a processor assigning a respective previously assigned priority and at least one respective previously assigned attribute to each of a plurality of messages received from respective trailer systems, the processor transmitting signals identifying a subset of the messages to be displayed based on the priorities of the messages; and
a visual signaling device, receiving the signals, capable of simultaneously displaying the subset of messages, the visual signaling device including a plurality of display segments, each of the segments conveying a relative priority and the vehicle system for a respective message in the subset.

31. The display system for a towed portion of a vehicle as set forth in claim 30, wherein;
each of the segments includes a plurality of light emitting devices; and
each of the light emitting devices in a respective segment displays a color representing the respective vehicle system as one of the attributes for one of the messages in the subset.

32. The display system for a towed portion of a vehicle as set forth in claim 30, wherein:
one of the respective attributes of each of the messages is a time to display the respective message;
the processor periodically determines if the time to display each of the respective messages has expired and determines if an additional message has arrived; and
the processor periodically prioritizes the unexpired messages with any newly arrived message and transmits subsequent signals to the visual signaling device identifying a subset of the unexpired messages and the newly arrived message to be displayed based on the priorities of the unexpired messages and the newly arrived message.

33. The display system for a towed portion of a vehicle as set forth in claim 30, wherein:
the processor transmits the signals to respectively size each of the segments according to the priority of the message to be displayed.

34. A system for conveying information, the system comprising:
means for simultaneously displaying a plurality of messages; and means for receiving a plurality of messages from respective systems via a communication system, identifying a respective previously assigned priority and at least one respective previously assigned attribute of each of the messages, and transmitting signals based on the priorities of the messages to cause the means for simultaneously displaying to simultaneously convey the respective priority and at least one attribute of at least one of the messages.
